(19) United States
(12) Patent Application Publication
(10) Pub. No.: US 2018/0053137 A1
(43) Pub. Date: Feb. 22, 2018

(54) SYSTEM AND METHOD FOR CUSTOMER SELECTED CONVENIENCE BASED PRICING OF SERVICE PROVIDERS

(71) Applicant: CHRISTOPHER LANG, BUCKEYE, AZ (US)

(72) Inventor: CHRISTOPHER LANG, BUCKEYE, AZ (US)

(21) Appl. No.: 15/472,060

(22) Filed: Mar. 28, 2017

Related U.S. Application Data
(60) Provisional application No. 62/376,752, filed on Aug. 18, 2016.

(51) Int. Cl. G06Q 10/06; G06Q 30/02; G06Q 50/10

(52) U.S. Cl. CPC G06Q 10/063118; G06Q 50/10; G06Q 30/0284

(57) ABSTRACT

A method for scheduling service by a service provider to a resident and/or business comprises: connecting with a server hosting a scheduling platform; displaying a calendar for selecting a day for the service; displaying a tiered appointment display for a selected calendar day, wherein the tiered appointment display shows a plurality of sets of time windows for service, each set of time windows having a plurality of time slots, each set of time windows having a different service window timeframes, wherein at least one of the different service window timeframes is a specific time for service, wherein each of the plurality of time slots has a corresponding price for service, the price for service being less for larger service widow timeframes; and selecting one of the plurality of time slots in one of the plurality of sets of time windows for service.

### TECHNICAL FIELD

The present application in general relates to scheduling systems, and more specifically, to a scheduling system which accumulates data which may allow service providers to more accurately calculate the cost associated with providing services thereby allowing the service provider to construct a tiered pricing model wherein customers have the option to pay increased fees for scheduling narrower delivery windows or an exact time, or to accept wider delivery windows for a reduced or zero up-charge.

### BACKGROUND

Many homeowner and businesses may require services, such as plumbing, Heating, Ventilation and Air Conditioning (HVAC) service, cable service, product delivery or other similar services where the home or business owner must be present to receive the service. Service providers typically schedule these services by assigning customers a “window” rather than an exact time that the services will be provided. Most service providers may assign a service window of approximately 3-4 hours. For example, a service provider may tell a customer to expect a service call anywhere from 8:00 am-noon. Service providers assign these service windows in order to optimize the service route for multiple services scheduled during that window. Non-obvious but significant operational costs may be incurred by service providers that do not make use of route optimization when planning their routes.

While service providers may need to optimize their service routes to optimize operational cost, customers are forced to accept the inconvenience of these service time windows. Since the customers do not know whether they will be among the first or last to receive service, customers of these services may be forced to accept the inconvenience and uncertainty of waiting for the service to be delivered during the window of time.

Therefore, it would be desirable to provide a system and method that overcomes the above. The system and method may accumulate data to allow service providers to better understand the costs of allowing customers to book times that are convenient for themselves and based on those costs provide a tiered pricing model wherein customers have the option to pay increased fees for scheduling narrower delivery windows or an exact time, or to accept wider delivery windows for a reduced or zero up-charge.

### SUMMARY

In accordance with one embodiment, a method for scheduling service by a service provider to a resident and/or business is disclosed. The method comprising: connecting with a server hosting a scheduling platform; displaying a calendar for selecting a day for the service; displaying a tiered appointment display for a selected calendar day, wherein the tiered appointment display shows a plurality of sets of time windows for service, each set of time windows having a plurality of time slots, each set of time windows having a different service window timeframes, wherein at least one of the different service window timeframes is a specific time for service, wherein each of the plurality of time slots has a corresponding price for service, the price for service being less for larger service window timeframes; and selecting one of the plurality of time slots in one of the plurality of sets of time windows for service.

In accordance with one embodiment, a computing device is disclosed. The computing device has a processor; a display coupled to the processor; a user interface coupled to the processor for entering data into the computing device; and a memory coupled to the processor, the memory storing program instructions that when executed by the processor, causes the processor to: connect with a server hosting a scheduling platform; display a calendar for selecting a day for the service; display a tiered appointment display for a selected calendar day, wherein the tiered appointment display shows a plurality of sets of time windows for service, each set of time windows having a plurality of time slots, each set of time windows having a different service window timeframes, wherein at least one of the different service window timeframes is a specific time for service, wherein each of the plurality of time slots has a corresponding price for service, the price for service being less for larger service window timeframes; and select one of the plurality of time slots in one of the plurality of sets of time windows for service.

In accordance with one embodiment, a method for scheduling service by a service provider to a resident and/or business is disclosed. The method comprising: displaying a calendar for selecting a day for the service; displaying a tiered appointment display for a selected calendar day, wherein the tiered appointment display shows a plurality of sets of time windows for service, each set of time windows having a plurality of time slots, each set of time windows having a different service window timeframes, wherein at least one of the different service window timeframes is a specific time for service, wherein each of the plurality of time slots has a corresponding price for service: and updating the corresponding price for service based on current service schedule.

### BRIEF DESCRIPTION OF THE DRAWINGS

The present application is further detailed with respect to the following drawings. These figures are not intended to limit the scope of the present invention bat rather illustrate certain attributes thereof.

FIG. 1 is a diagram of an exemplary system for convenience based pricing of service providers according to one aspect of the present application;

FIG. 2 is a simplified block diagram showing an illustrative computing device depicted in FIG. 1 in accordance with one aspect of the present application;

FIG. 3 is a screen shot of a service provider using the exemplary system according to one aspect of the present invention;

FIG. 4A is an example of an interface of the exemplary system for analyzing cost of the service provider in accordance with one aspect of the present application;

FIG. 4B1 is an example of an interface of the exemplary system for analyzing cost of the service provider in accordance with one aspect of the present application;

FIG. 4B2 is an example of an interface of the exemplary system for analyzing cost of the service provider optimized in accordance with one aspect of the present application;

FIG. 4C is an example of an interface of the exemplary system for analyzing cost of the service provider in accordance with one aspect of the present application;

FIG. 5 is an example of an interface of the exemplary system for analyzing cost of the service provider in accordance with one aspect of the present application;

FIG. 6 is an example of an interface of the exemplary system for the service provider to set prices; and

FIG. 7 is an example of an interface of the exemplary system for the service provider to set prices.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method accumulates data and gives service providers the ability to calculate the average additional costs (actual and/or opportunity) of allowing services to be scheduled for more precise windows and exact times compared to the, lesser costs that wider delivery windows achieve by allowing greater efficiency gains to be realized. The system and method enables the service provider to use the cost information to construct a tiered pricing model that is fed into a scheduling system that presents customers with the option to pay increased fees for scheduling narrower delivery windows or an exact time, or to accept wider delivery windows for a reduced or zero up-charge.

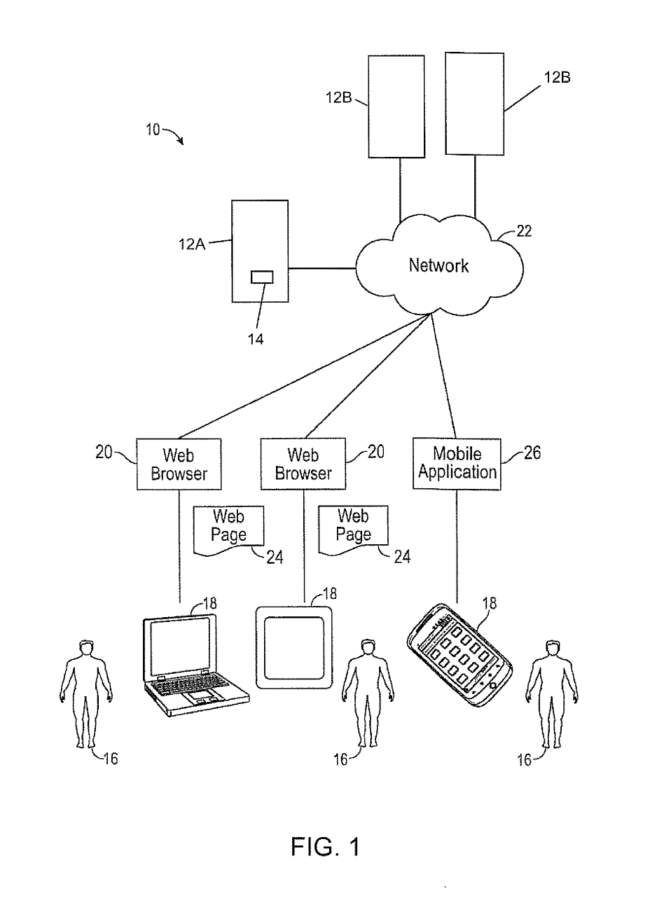

Referring now to FIG. 1, a system 10 may be shown. The system 10 may have a server 12A. The server 12A may be used to host a service provider scheduling platform 14 (hereinafter scheduling platform) of the present invention. One or more other servers 16 may be coupled to the server 12A via a network 22. The server 12A may accumulate data from the servers 12B. The server 12A may accumulate data from the servers 12B relating to scheduling/operational cost from different service providers. In general, the server 12 may use data from servers 12B storing data from service providers in the same and/or similar communities and in the same and/or similar industries. Thus, for example, if the server 12 was hosting the service provider scheduling platform 14 for a plumbing company in Des Moines, Iowa, the server 12A would probably not accumulate data from a server 12B having data related to a appliance delivery company in New York City, N.Y. By accumulating the data from different servers 12B of service providers in the same and/or similar communities and in the same and/or similar industries, the scheduling platform 14 may construct a tiered cost model identifying operational costs to the business which can be used to construct a tiered pricing model wherein customers have the option to pay increased fees for scheduling narrower delivery windows or an exact time, or to accept wider delivery windows for a reduced or zero up-charge.

Individuals 16 may use one or more computing devices 18 to access the scheduling platform 14 that may be hosted on the server 12. The computing devices 18 may be a personal computer system, handheld of laptop device, tablet device, mobile phone device, server computer system, multiprocessor system, microprocessor-based system, set top boxes, programmable consumer electronics, network PCs, and distributed cloud computing environments that include any of the above systems or devices, and the like. The computing device 18 may be described in the general context of computer system executable instructions, such as program modules, being executed by a computer system as may be described below.

The computing device 18 may be loaded with an operating system. The operating system of the computing device 18 may manage hardware and software resources of the computing device 18 and provide common services for computer programs running on the computing device 18. The computing device 18 may be loaded with a web browser 20. The web browser 20 may allow the computing device 18 to gain online access to the network 22 such as the World Wide Web. The web browser 20 may be Microsoft® Internet Explorer, Google® Chrome, Mozilla® Firefox, Apple® Safari or similar browsing applications. By connecting to the network 22, the computing device 18 may access a website 24 associated with the scheduling platform 14 hosted on the server 12A.

Alternatively, or in addition to, the computing device 18 may download a mobile application 26. The mobile application 26 may access and communicate with the scheduling platform 14 hosted on the server 12A. By connecting to the network 22, the computing device 18 may access and communicate with the scheduling platform 14 hosted on the server 12A via the mobile application 26.

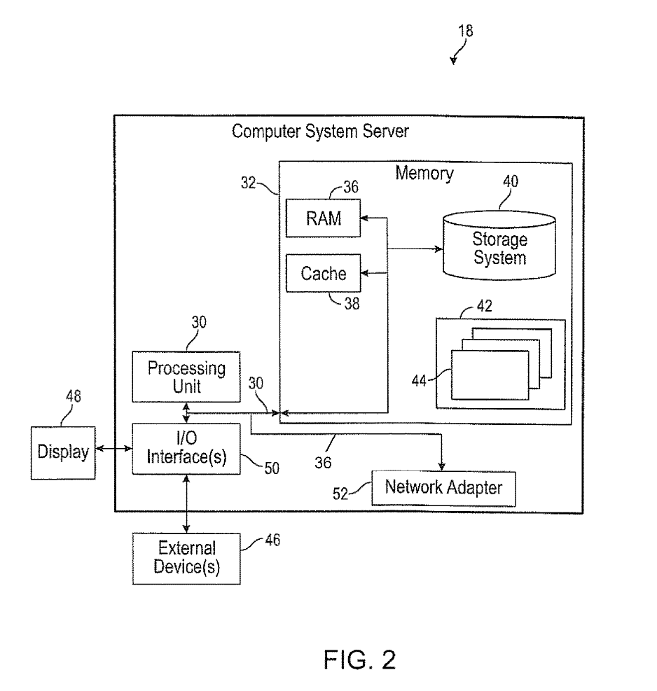

Referring now to FIG. 2, the server 12A and the computing devices 18 may be described in more detail in terms of the machine elements that provide functionality to the systems and methods disclosed herein. The components of the server 12A and the computing devices 18 may include, but are not limited to, one or more processors or processing units 30, a system memory 32, and a system bus 34 that couples various system components including the system memory 32 to the processor 30. The server 12A and the computing devices 18 may typically include a variety of computer system readable media. Such media could be chosen from any available media that is accessible by the server 12A and/or the computing devices 18, including non-transitory, volatile and non-volatile media, removable and non-removable media. The system memory 32 could include one or more computer system readable media in the form of volatile memory, such as a random access memory (RAM) 36 and/or a cache memory 38. By way of example only, a storage system 40 may be provided for reading from and writing to a non-removable, non-volatile magnetic media device typically called a “hard drive”.

The system memory 32 may include at least one program product/utility 42 having a set (e.g., at least one) of program modules 44 that may be configured to carry out the functions of embodiments of the invention. The program modules 44 may include, but is not limited to, an operating system, one or more application programs, other program modules, and program data. Each of the operating systems, one or more application programs, other program modules, and program data or some combination thereof, may include an implementation of a networking environment. The program modules 44 generally carry out the functions and/or methodologies of embodiments of the invention as described herein. For example, the program modules 44 may contain the scheduling platform 14 in the server 12A and/or the mobile application 26 on the computing device 18 to access the scheduling platform,14 stored on the server 12.

The computing device 18 may communicate with one or more external devices 46 such as a keyboard, a pointing device, a display 48, and/or any similar devices (e.g., network card, modern, etc.) that enable the computing device 18 to communicate with the server 14 (FIG. 1). Such communication may occur via Input/Output (I/O) interfaces 50. Alternatively, the computing devices 18 may communicate with one or more networks such as a local area network (LAN), a general wide area network (WAN), and/or a public network (e.g., the network 22 shown in FIG. 1) via a network adapter 52. As depicted, the network adapter 52 may communicate with the other components of the computing device 18 via the bus 36.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (fir example, storage system 40) may be utilized. In the context of this disclosure, a computer readable storage medium may be any tangible or non-transitory medium that can contain, or store a program (for example, the program product 42) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

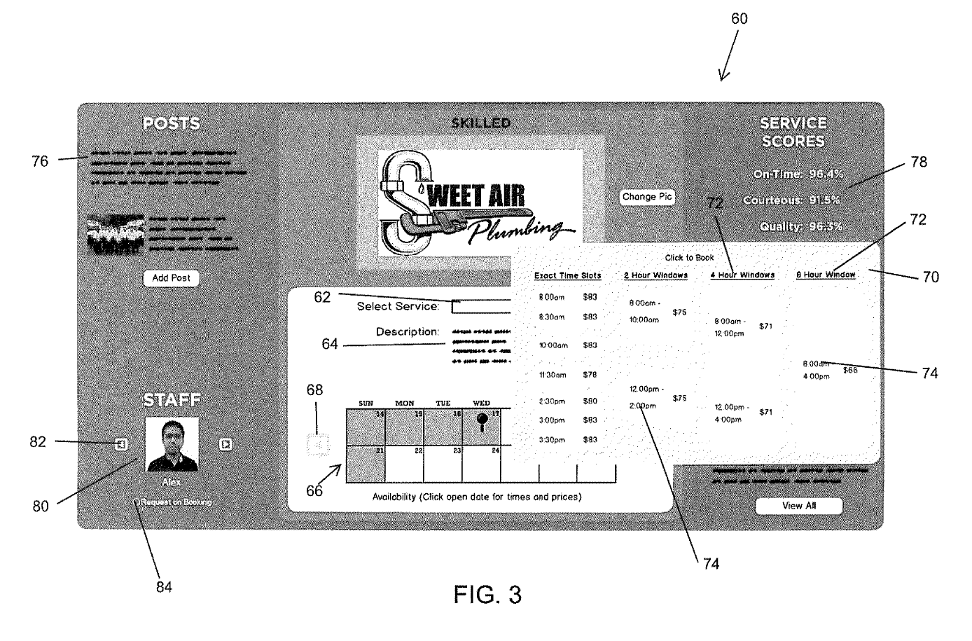

Referring to FIG. 3, an exemplary embodiment of a screen shot 60 of the scheduling platform 14 stored on the server 12A may be seen. The screen shot 60 may form part of the webpage 24 of the scheduling platform 14 and/or may form part of the mobile application 26. The screen shot 60 may have a menu 62 for selecting a type of service to be provided. The menu 62 n ay list the different types of services provided by the service provider. In accordance with one embodiment, the menu 62 may be a pull-down type menu wherein the pull-down menu may list different services provided by the service provider. The above is given as an example and should not be seen in a limiting manner as other types of menus may be used.

The screen shot 62 may provide an area 64 wherein the customer 18 (FIG. 1) may enter a description of the services requested. In accordance with one embodiment, the customer 18 may enter a description of the services requested by using an external device 46 of the computing device 18. The customer 18 may provided additional information about the services selected using the menu 62, provided special instructions/request, or provided other information.

The screen shot 62 may provided a calendar 66. The calendar 66 may be used to allow the customer 18 to select a specific day for service. In accordance with one embodiment, an input area 68 may be provided to change the day/week/month currently being displayed. By using an external device 46 of the computing device 18, the customer may select a specific day for service on the calendar 66 being displayed. Once a specific day is selected, an appointment screen 70 may be displayed. The appointment screen 70 may display a tiered appointment/pricing structure. The appointment screen may be divided into a plurality of timeframes 72 wherein each timeframe 72 may have one or more time slots 74 for scheduling an appointment. Each timeframe 72 may provide one or more appointments wherein the appointments may have different windows for services. For example, one timeframe 72 may allow the customer 18 to select an appointment having a service window of 8 hours, another timeframe 72 may show appointments having a service window of 4 hours, another timeframe 72 may show appointments having a service window of 2 hours and another timeframe may show appointments for a specific time. Each appointment may identify a price for the service requested. In accordance with one embodiment, the price listed may be just for the initial service call.

As may be seen the price listed may vary based on the timeframe 72 selected. This may allow the customer 18 the option of paying higher fees for a more specific service window. For example, if the customer 18 is going to be at home all day, the customer may not care when the service provider is going to come and may select an 8 hour window of service. However, another customer 18 may want to have the service provider come at a specific time so that the customer 18 may plan his/her schedule for the remainder of the day.

The customer 18 may select an appointment slot within one of the service windows by using an external device 46 of the computing device 18. In accordance with one embodiment, the customer 18 may “click” a desired appointment slot within one of the service windows. Once a desired appointment slot is selected, the customer 1 may be sent to confirmation screen. The confirmation screen may allow the customer to enter specific information regarding contact information of the customer 18, address for service, as well as other requisite information. Once the information is entered and sent the customer 18 may receive confirmation of the selected appointment. In accordance with one embodiment, confirmation may be sent via email, text, phone call, or by other suitable measures. In accordance with one embodiment, the customer 18 may need to register and provide contact information prior to using the system 10. This may allow the system 10 to display more accurate scheduling information as the customer's location is already known.

The screen shot 60 may show a review section 76. The review section 76 may allow customers 18 to enter and/or read reviews of the service provider. This may allow customers 18 to be informed about the service provide prior to scheduling an appointment. When entering a review, the customer may enter information related to the quality of service, the service provide was on-time, if the service representative was courteous and the like. In accordance with one embodiment the customer 18 may be given the chance to write review only after the service has been performed.

The screen shot 60 may have a service score area 78. The service score area 78 may show information related to the quality of service provided by the service provider. For example, the service area 78 may show how often the service provider is on-time, a percentage of customers 18 that feel the service provider is courteous, a ranking of the quality of service provided by the service provider, as well as other information related to the services provided.

The screen shot 60 may provide a staff area 80. The staff area 80 may allow the customer 18 to look at the different service representatives of the service providers. The customer may use input keys 82 to scroll through different staff members. The staff area 80 may provide a bio and/or review of the service representative. Customers may select a specific service representative for a service call by selecting a “Request on Booking” key 84 when making an appointment.

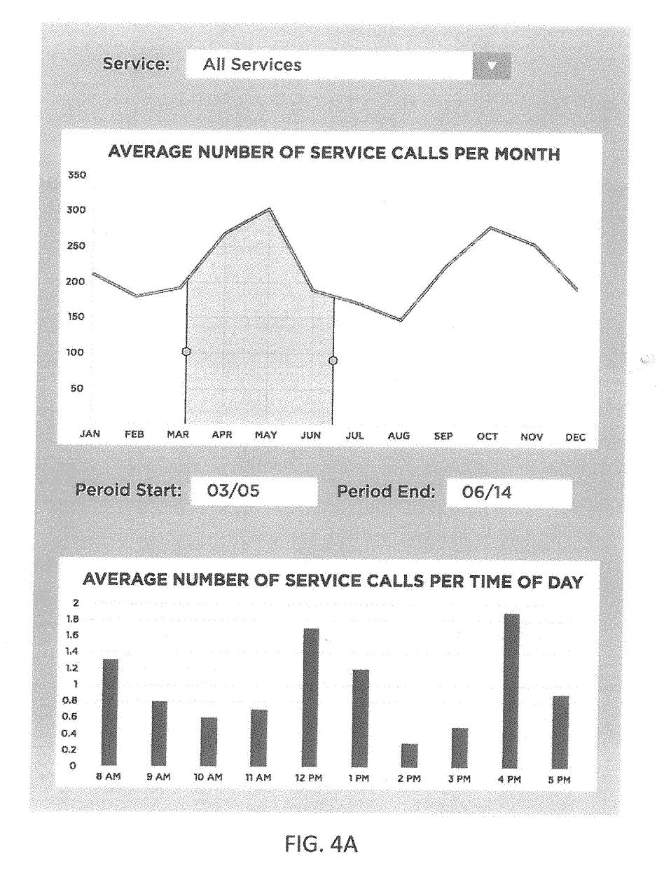

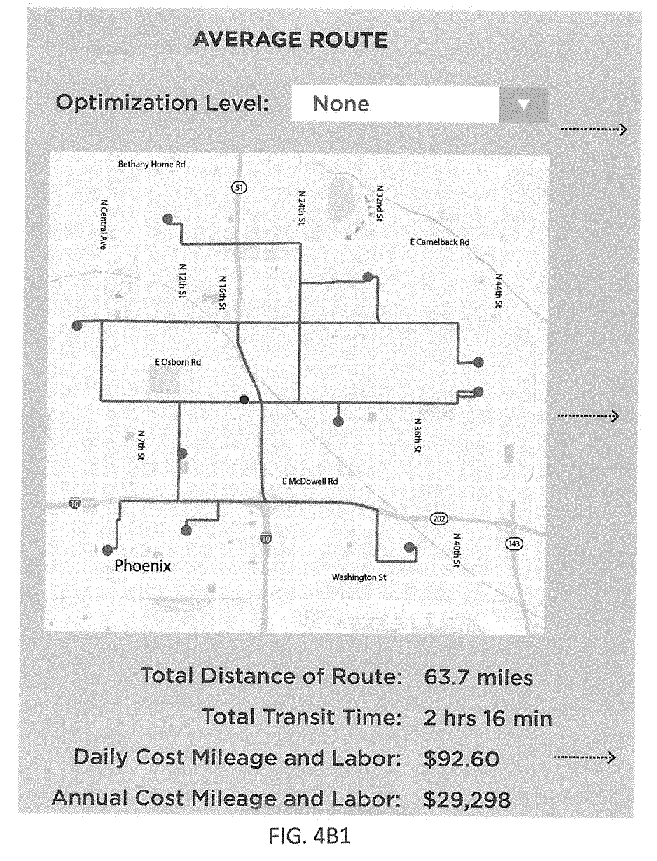

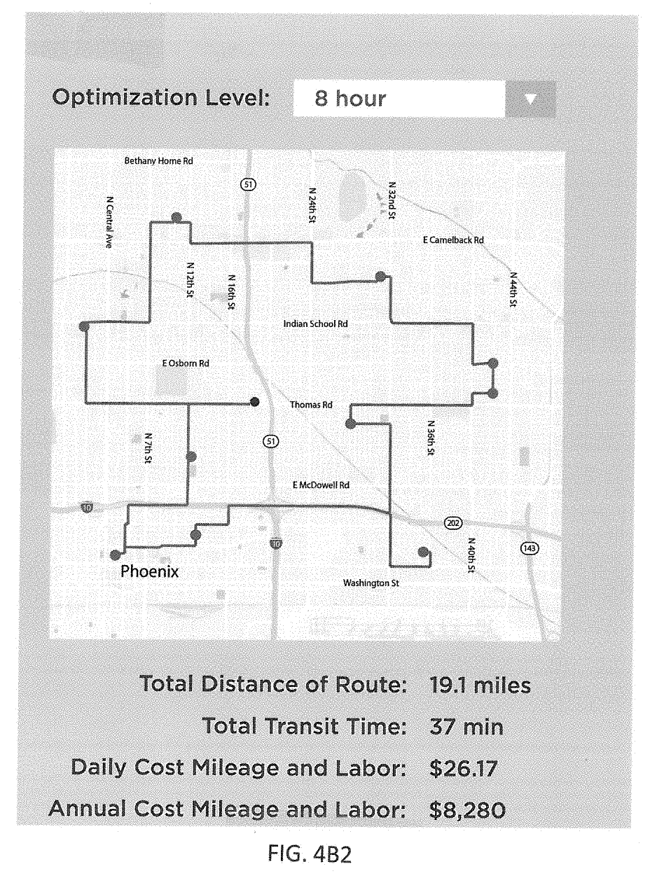

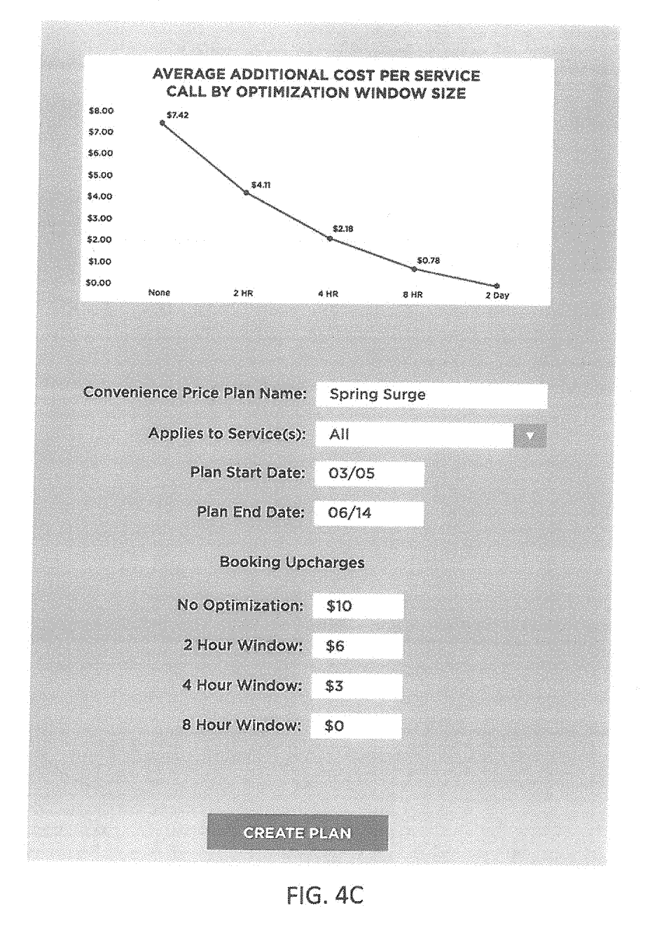

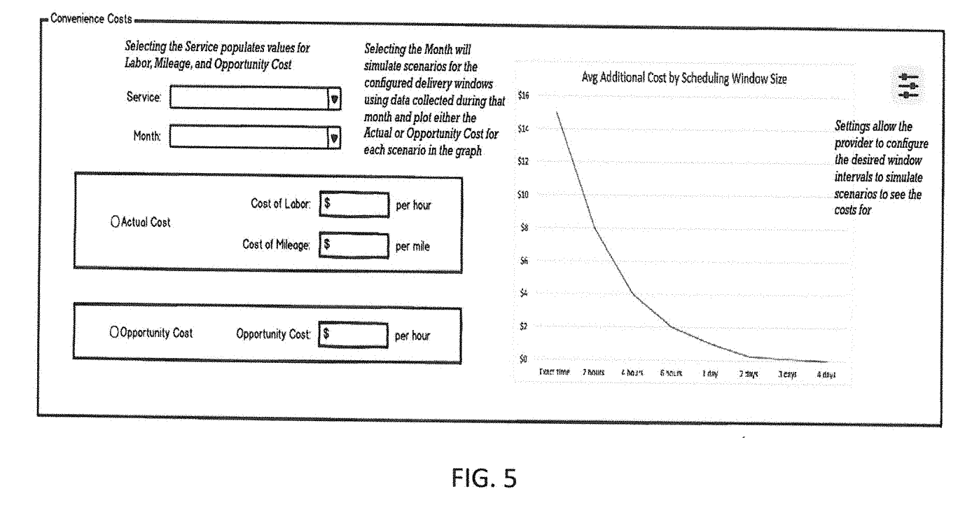

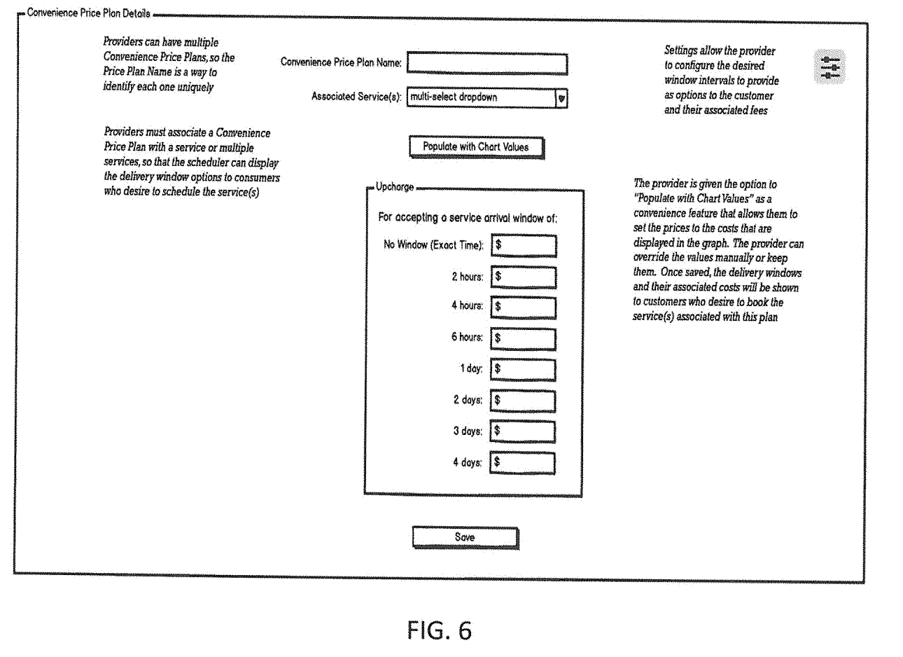

The system 10 may accumulate data in order to give service providers the ability to calculate the average costs (actual and/or opportunity) of allowing services to be scheduled for more precise windows and exact times compared to the lesser costs that wider delivery windows achieve by allowing greater efficiency gains to be realized. The system 10 may accumulate data from the service provider. In addition, the system 10 may accumulate data from service providers in the same and/or similar communities and in the same and/or similar industries. As may be seen in FIGS. 4A-6, the system 10 may provide different interfaces which may use the data collected by the system 10 relating to customer location data and scheduling times for a given period of time. The data may be segmented by time, so that seasonal fluctuations may be isolated and used to more accurately predict cyclical trends. The system 10 may record the number of service calls, and number of calls per day/time. The system 10 may monitor the routes taken by the service providers and calculate the total distance traveled, total travel time, daily cost based on mileage and labor, and a yearly cost based on mileage and labor.

Using the above data (histograms), the system 10 may simulate a set of configurable booking scenarios, computing the average operational cost (labor and fuel) and average opportunity cost (time lost which could have beers used to deliver paid services) for each booking based on different scenarios. One set of configurable scenarios might be:
Scenario 1—The costs if every customer booked at an exact time (no window)
Scenario 2—The costs if every customer accepted a 2-hour window
Scenario 3—The costs if every customer accepted a 4-hour window
Scenario 4—The costs if every customer accepted a 6-hoar window
Scenario 5—The costs if every customer accepted a 1-day window
Scenario 6—The costs if every customer accepted a 2-day window
Scenario 7—The costs if every customer accepted a 1-week window

While expecting customers to accept a 1-week window might not be practical, the idea is for the service provider to have the ability to view the cost savings from schedule optimization and to see the window in which the savings flatten out. The window at which the savings flatten out could then be used as a no up-charge baseline to start the convenience pricing from and the difference between this cost and the costs from scenarios where the window is smaller could be viewed as the true cost of that convenience.

Using the data from the simulated scenarios as a starting point, the service provider can configure multiple windows to set fees that may offset the cost of allowing the customer to refine their scheduled delivery window for a service offering. This fee structure may become part of an interface as may be seen in FIG. 3 that is published to the customer to select from at the time of scheduling the service.

As stated above, the consumer may select the delivery window that he/she is willing to accept along with its corresponding fee, and the schedule then displays the time slots or windows that are available to schedule service delivery at. If the consumer has chosen an exact time (and accepted the associated fee for selecting it) after choosing a time the appointment becomes scheduled in the service provider's schedule. If the consumer has chosen a window of time, after selecting an available window that fits their schedule, the service is bound to that time window in the service provider's schedule, but not assigned an exact time until either the window of time reaches its capacity of deliveries and optimization can be performed, or it hasn't reached capacity but time has come for the scheduler to perform optimization on the scheduled deliveries so the provider can begin the service delivery route

The system 10 may accumulate the scheduling data and a route optimization algorithm may compute a route and schedule in which all services may be provided to the customers 18. The route optimization algorithm may provide a route that may mathematically approach the most efficient route possible and incur considerably less total time and cost to the service provider than allowing customers to be scheduled at any available exact time that is convenient for them. The route optimization algorithm may take into account location of appointments, time of appointments, travel patterns such as road congestion, construction, etc. as well as other variables.

The system 10 may track the location and availability of all resources required to deliver each service that the service provider offers at a time that is agreed to by the consumer. Using that data in conjunction with the location that the customer desires the service to be performed at, the system must be able to compute times that the provider is available to deliver the service to the consumer at the desired location.

The system 10 may accumulate data in order to give service providers the ability to calculate a projected business costs for each potential time slot prior to displaying to the customer. As stated above, the system 10 may use accumulated data ability to calculate projected business costs. The accumulated data may be from the service provider. In addition, the system 10 may accumulate data for a service providers in the same and/or similar communities and in the same and/or similar industries. The data collected may be related to cost associated with the employee providing the service, cost associated with travel, as well as other variables. The system 10 is a dynamic system. The system 10 may continually adjust pricing based on the current schedule. The system 10 may adjust pricing of individual time windows to encourage or discourage selection. This may be done for route optimization and/or to lessen business cost of the service provider.

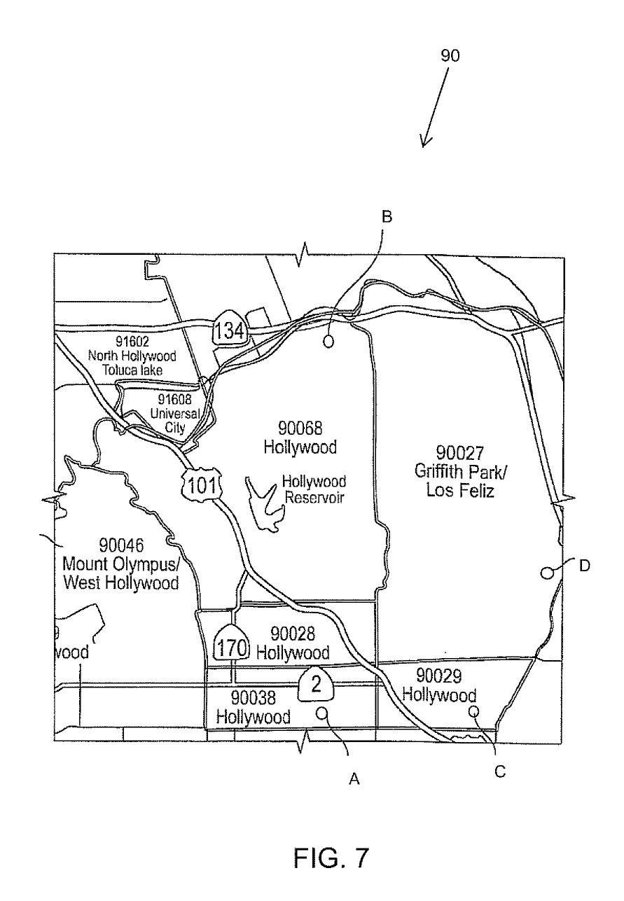

Referring to FIG. 7, a map 90 may be seen. On the map a customer A may have used the system 10 to select a specific time frame for service. For example, customer A may have selected a service time of Wednesday at 11:00 am. When customer B uses the system 10, the system may discourage selection of time frames around the Wednesday at 11:00 am by charging higher fees for these time frames due to the distances between customer A and customer B. If customer B does wish to schedule service on the same Wednesday as customer A and for a specific time, the system 10 may incentives selection of time frames either early in the morning or later in the late afternoon. Thus, for example, the system may charge higher fees for selecting a specific time of 10:00 am or 12:00 am on Wednesday but charge a reduced incentivized fee for selecting an exact time of 7:00 am on Wednesday or 5:00 pm on Wednesday. The system 10 may charge a further reduced incentivized fee if customer B was willing to selected a more flexible time window such as 2 hour window of service. The more flexible customer B is the greater reduction in pricing.

Next, when customer C uses the system, the system 10 may observe that customer C is located within a predefined radius of customer A. Thus, the system 10 may encourage selection of time frames proximate the Wednesday at 11:00 am in order to try and minimize business cost for the service provider and optimize the travel route. The system 10 may incentivize customer C by reducing the fees for selected time windows proximate the Wednesday at 11:00 am time frame. Thus, for example, the system 10 may charge lower fees for selecting a specific time of 10:00 am or 12:00 am on Wednesday. The system 10 may charge a further reduced incentivized fee if customer C was willing to selected a more flexible time window such as 2 hour window of service. The more flexible customer B is the greater reduction in pricing.

Next, when customer D uses the system 10, the system 10 may try to optimize the service route if customer D chooses service on Wednesday. For example, if customer B scheduled a flexible window between 7:00 am-9:00 am on Wednesday, customer A scheduled a set time of 11:00 am on Wednesday, customer C scheduled a flexible window between 12:00 noon-2:00 pm on Wednesday, the system 10 may encourage selection of time frames after the 2:00 pm time window. The system 10 may try to incentivize customer D by reducing the fees for selected time windows after the Wednesday at 2:00 pm time frame.

The foregoing description is illustrative of particular embodiments of the invention, but is not meant to be a limitation upon the practice thereof. The following claims, including all equivalents thereof, are intended to define the scope of the invention.

What is claimed is:

1. A method for scheduling service by a service provider to a resident and/or business comprising:
connecting with a server hosting a scheduling platform;
displaying a calendar for selecting a day for the service;
displaying a tiered appointment display for a selected calendar day, wherein the tiered appointment display shows a plurality of sets of time windows for service, each set of time windows having a plurality of time slots, each set of time windows having a different service window timeframes, wherein at least one of the different service window timeframes is a specific time for service, wherein each of the plurality of time slots has a corresponding price for service, the price for service being less for larger service window timeframes; and
selecting one of the plurality of time slots in one of the plurality of sets of time windows for service.

2. The method of claim 1, comprising:
accumulating historical data associated with providing service;
calculating a projected business costs; and
assigning the corresponding price for service for each time slot.

3. The method of claim 2, comprising updating the corresponding price for service based on current service schedule.

4. The method of claim 2, comprising incentivizing the corresponding price for service based on current service schedule.

5. The method of claim 4, comprising:
increasing the corresponding price for service for specific time slots proximate a currently scheduled time slot when a location of a present scheduler is outside a predetermined radius of a location for the currently scheduled time slot; and
decreasing the corresponding price for service for specific time slots proximate the currently scheduled time slot when the location of the present scheduler is within a predetermined radius of the location for the currently scheduled time slot.

6. The method of claim 1, comprising sending a confirmation of the selected time slot.

7. The method of claim 1, comprising entering verification information for the service being requested.

8. The method of claim 1, comprising displaying a review area showing customer reviews of a service provider.

9. The method of claim 1, comprising displaying a service score area showing information about quality of service of a service provider.

10. The method of claim 1, comprising displaying a staff area showing different employees of the service provider.

11. A computing device comprising:
a processor;
a display coupled to the processor;
a user interface coupled to the processor for entering data into the computing device; and
a memory coupled to the processor, the memory storing program instructions that when executed by the processor, causes the processor to:
connect with a server hosting a scheduling platform;
display a calendar for selecting a day for the service;
display a tiered appointment display for a selected calendar day, wherein the tiered appointment display shows a plurality of sets of time windows for service, each set of time windows having a plurality of time slots, each set of time windows having a different service window timeframes, wherein at least one of the different service window timeframes is a specific time for service, wherein each of the plurality of time slots has a corresponding price for service, the price for service being less for larger service window timeframes; and
select one of the plurality of time slots in one of the plurality of sets of time windows for service.

12. The computing device of claim 11, wherein the memory storing program instructions that when executed by the processor, causes the processor to:
accumulate historical data associated with providing service;
calculate a projected business costs; and
assign the corresponding price for service for each time slot.

13. The computing device of claim 12, wherein the memory storing program instructions that when executed by the processor, causes the processor to update the corresponding price for service based on current service schedule.

14. The computing device of claim 12, wherein the memory storing program instructions that when executed by the processor, causes the processor to incentivize the corresponding price for service based on current service schedule.

15. The computing device of claim 14, wherein the memory storing program instructions that when executed by the processor, causes the processor to:
increase the corresponding price for service for specific time slots proximate a currently scheduled time slot when a location of a present scheduler is outside a predetermined radius of a location for the currently scheduled time slot; and
decrease the corresponding price for service for specific time slots proximate the currently scheduled time slot when the location of the present scheduler is within a predetermined radius of the location for the currently scheduled time slot.

16. The computing device of claim 11, wherein the memory storing program instructions that when executed by the processor, causes the processor to display a staff area showing different employees of the service provider.

17. A method for scheduling service by a service provider to a resident and/or business comprising:
displaying a calendar for selecting a day for the service;
displaying a tiered appointment display for a selected calendar day, wherein the tiered appointment display shows a plurality of sets of time windows for service, each set of time windows having a plurality of time slots, each set of time windows having a different service window timeframes, wherein at least one of the different service window timeframes is a specific time for service, wherein each of the plurality of tune slots has a corresponding price for service; and
updating the corresponding price for service based on current service schedule.

18. The method of claim 17, comprising incentivizing the corresponding price for service based on current service schedule.

19. The method of claim 18, comprising:
increasing the corresponding price for service for specific time slots proximate a currently scheduled time slot when a location of a present scheduler is outside a predetermined radius of a location for the currently scheduled time slot; and
decreasing the corresponding price for service for specific time slots proximate the currently scheduled time slot when the location of the present scheduler is within a predetermined radius of the location for the currently scheduled time slot.

20. The method of claim 17, wherein the price for service being less for larger service window timeframes, the corresponding price service based on the projected business cost calculated.
